(19) United States
(12) Patent Application Publication
(10) Pub. No.: US 2026/0148457 A1
(43) Pub. Date: May 28, 2026

(54) Medical Imaging Data Pair Generation Method Medical Image Imaging Method and Medical Imaging System

(71) Applicant: GE Precision Healthcare LLC, Waukesha, WI (US)

(72) Inventors: Xiaokun Huang, Beijing (CN); Xueli Wang, Beijing (CN); Jingting Li, Beijing (CN); Yuwen Dong, Beijing (CN)

(21) Appl. No.: 19/400,783

(22) Filed: Nov. 25, 2025

(30) Foreign Application Priority Data
Nov. 28, 2024 (CN) 202411729637.4

(51) Int. Cl. G06T 11/00; G06T 3/4046; G06T 5/60; G06T 5/70; G06T 7/00

(52) U.S. Cl. CPC G06T 12/20; G06T 3/4046; G06T 5/60; G06T 5/70; G06T 7/0012; G06T 2207/10112; G06T 2207/20081; G06T 2207/20084; G06T 2207/30068; G06T 2211/441

(57) ABSTRACT

A data pair generation method, a medical image imaging method, and a medical imaging system are disclosed. An example method includes receiving a raw three-dimensional projection data set, wherein the raw three-dimensional projection data set is obtained by scanning an object using a medical imaging system; performing multiplication on the raw three-dimensional projection data set in at least one dimension to obtain a multiplied projection data set having a higher resolution relative to the raw three-dimensional projection data set; splitting the multiplied projection data set in the at least one dimension into a first projection data subset and a second projection data subset; and generating at least one imaging data pair based on the first projection data subset and the second projection data subset, the imaging data pair including an imaging data pair formed on the basis of the first projection data subset and the second projection data subset.

### CROSS-REFERENCE TO RELATED APPLICATIONS

This application claims priority to Chinese Application No. 202411729637.4, filed on Nov. 28, 2024, the disclosure of which is incorporated herein by reference in its entirety.

### TECHNICAL FIELD

The present disclosure relates to the field of image processing, and in particular, to a medical imaging data pair generation method, a medical image imaging method, and a medical imaging system.

### BACKGROUND

Imaging techniques allow for non-invasive acquisition of images of internal structures or features of a subject (such as a patient). Digital X-ray imaging systems produce digital data that can be reconstructed into radiographic images, such as in computed tomography (CT) or digital breast tomosynthesis (DBT) imaging processes. In a digital X-ray imaging system, radiation from a source is directed toward a subject. A portion of the radiation passes through the subject and impinges on a detector. The detector includes an array of discrete picture elements or detector pixels, and processing is performed on the basis of the amount or intensity of radiation impinging on each pixel region to obtain projection data. Complete projection data can be used to reconstruct accurate slice images for diagnosis. These images are used to identify and/or examine internal structures and organs within the patient. If the image resolution is higher, the internal structures and organs can be more clearly distinguished, thereby obtaining a more accurate diagnosis result.

### SUMMARY

It should be understood that both the foregoing general description and the following detailed description of the present invention are exemplary and illustrative, and are intended to provide further explanation of the present invention as claimed.

According to a first aspect of the present disclosure, provided is a method for generating a medical imaging data pair, including: receiving a raw three-dimensional projection data set, wherein the raw three-dimensional projection data set is obtained by scanning an object under examination by a medical imaging system; performing multiplication on the raw three-dimensional projection data set in at least one dimension to obtain a multiplied projection data set having a higher resolution relative to the raw three-dimensional projection data set; splitting the multiplied projection data set in the at least one dimension into a first projection data subset and a second projection data subset; and generating at least one imaging data pair on the basis of the first projection data subset and the second projection data subset, the imaging data pair including an imaging data pair formed on the basis of the first projection data subset and the second projection data subset and/or an imaging data pair formed by an image reconstructed from the first projection data subset and an image reconstructed from the second projection data subset.

In an embodiment, the raw three-dimensional projection data set is acquired by a detector of the medical imaging system and includes three dimensions: a row direction, a channel direction, and a view direction, the row direction indicating a direction of the detector in which the object under examination moves toward or out of the medical imaging system, the channel direction indicating an extension direction of the detector, perpendicular to the row direction, arranged to partially surround the object under examination, and the view direction indicating an angle at which the detector acquires the raw three-dimensional projection data set at different positions around the object under examination.

In an embodiment, the first projection data subset and the second projection data subset are obtained by splitting the multiplied projection data set alternately in the view direction and/or the channel direction.

In an embodiment, the first projection data subset includes data blocks at first positions in the view direction, and the second projection data subset includes data blocks at second positions in the view direction, the first positions and the second positions alternating in the view direction; and/or the first projection data subset includes data blocks at third positions in the channel direction, and the second projection data subset includes data blocks at fourth positions in the channel direction, the third positions and the fourth positions alternating in the channel direction.

In an embodiment, the method further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

In an embodiment, performing multiplication on the raw three-dimensional projection data set in at least one dimension includes up-sampling the raw three-dimensional projection data set in at least one of the channel direction, the row direction, and the view direction.

In an embodiment, up-sampling the raw three-dimensional projection data set in the view direction includes using a deep learning neural network to perform up-sampling, the deep learning neural network including a SwinIR transformer.

According to a second aspect of the present disclosure, provided is a method for medical image imaging, including: receiving a medical imaging data pair, wherein the medical imaging data pair is generated by the following steps: receiving a raw three-dimensional projection data set, wherein the raw three-dimensional projection data set is obtained by scanning an object under examination by a medical imaging system; performing multiplication on the raw three-dimensional projection data set in at least one dimension to obtain a multiplied projection data set having a higher resolution relative to the raw three-dimensional projection data set; splitting the multiplied projection data set in the at least one dimension into a first projection data subset and a second projection data subset; and generating at least one imaging data pair on the basis of the first projection data subset and the second projection data subset, the imaging data pair including an imaging data pair formed on the basis of the first projection data subset and the second projection data subset and/or an imaging data pair formed by an image reconstructed from the first projection data subset and an image reconstructed from the second projection data subset; and generating a medical image on the basis of the medical imaging data pair.

In an embodiment, the raw three-dimensional projection data set is acquired by a detector of the medical imaging system and includes three dimensions: a row direction, a channel direction, and a view direction, the row direction indicating a direction of the detector in which the object under examination moves toward or out of the medical imaging system, the channel direction indicating an extension direction of the detector, perpendicular to the row direction, arranged to partially surround the object under examination, and the view direction indicating an angle at which the detector acquires the raw three-dimensional projection data set at different positions around the object under examination.

In an embodiment, the first projection data subset and the second projection data subset are obtained by splitting the multiplied projection data set alternately in the view direction and/or the channel direction.

In an embodiment, the first projection data subset includes data blocks at first positions in the view direction, and the second projection data subset includes data blocks at second positions in the view direction, the first positions and the second positions alternating in the view direction; and/or the first projection data subset includes data blocks at third positions in the channel direction, and the second projection data subset includes data blocks at fourth positions in the channel direction, the third positions and the fourth positions alternating in the channel direction.

In an embodiment, the method further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

In an embodiment, performing multiplication on the raw three-dimensional projection data set in at least one dimension includes up-sampling the raw three-dimensional projection data set in at least one of a channel direction, a row direction, and a view direction.

According to a third aspect of the present disclosure, provided is a medical imaging system, including: a scanning device configured to acquire a raw three-dimensional projection data set of an object under examination; and a processor configured to execute the method according to any one of the foregoing items.

According to a fourth aspect of the present disclosure, provided is a non-transient computer-readable medium, having instructions stored thereon, wherein the instructions are executable by a processor to implement the method according to any one of the foregoing items.

### BRIEF DESCRIPTION OF THE DRAWINGS

The present disclosure can be better understood by means of the description of the exemplary embodiments of the present disclosure in conjunction with the drawings, in which:

FIG. 1 shows a schematic diagram of an exemplary CT system 100 configured for CT imaging;

FIG. 2 shows an exemplary imaging system similar to the CT system in FIG. 1;

FIG. 3 shows a schematic diagram of a CT system when examining a patient;

FIG. 4 shows a flowchart of a method for generating a medical imaging data pair according to an embodiment of the present disclosure;

FIG. 5 shows a schematic diagram of a raw three-dimensional projection data set and a multiplied projection data set according to an embodiment of the present disclosure;

FIG. 6 shows a schematic diagram of splitting a multiplied projection data set in a view direction according to an embodiment of the present disclosure;

FIG. 7 shows a schematic diagram of splitting a multiplied projection data set in a channel direction according to an embodiment of the present disclosure;

FIG. 8 shows a schematic diagram of splitting a multiplied projection data set in a view direction and a channel direction according to an embodiment of the present disclosure;

FIG. 9 shows a flowchart of a method for model training according to an embodiment of the present disclosure;

FIG. 10 shows a schematic diagram of training an image denoising model using a medical imaging data pair according to an embodiment of the present disclosure;

FIG. 11 shows a flowchart of a method for medical image imaging according to an embodiment of the present disclosure; and

FIG. 12 shows an exemplary block diagram of a computing device according to an embodiment of the present disclosure.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific embodiments of the present disclosure will be described below, but it should be noted that in the specific description of these embodiments, for the sake of brevity of description, it is impossible to describe all features of the actual embodiments of the present disclosure in detail in this description. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for a person of ordinary skill in the art related to the content disclosed in the present disclosure, some design, manufacture, or production changes made on the basis of the technical content disclosed in the present disclosure are only common technical means, and should not be construed as the content of the present disclosure being insufficient.

References in the specification to “an embodiment”, “embodiment”, “example embodiment”, and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless otherwise defined, the technical or scientific terms used in the claims and the description should be as they are usually understood by those possessing ordinary skill in the technical field to which they belong. The terms “include” or “include” and similar words indicate that an element or object preceding the terms “include” or “include” encompasses elements or objects and equivalent elements thereof listed after the terms “include” or “include”, and do not exclude other elements or objects.

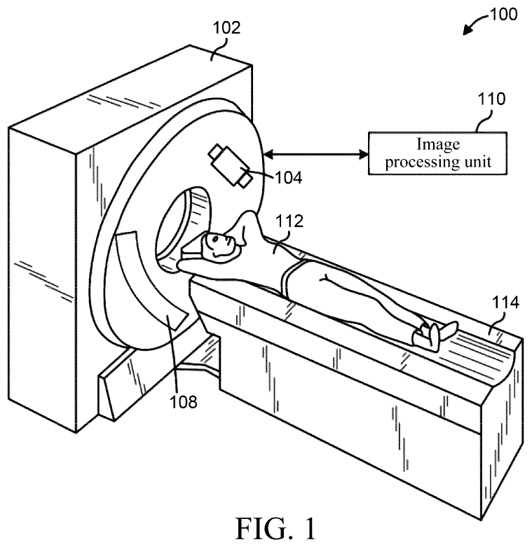

Embodiments of the present disclosure will be described below by way of example with reference to FIGS. 1 to 12. Although a CT system is described by way of example, it should be understood that the techniques of the present disclosure are broadly applicable to various fields of non-destructive examination. The techniques of the present disclosure may also be useful when applied to images acquired by using other imaging modalities, such as an X-ray imaging system, a magnetic resonance imaging (MRI) system, a positron emission tomography (PET) imaging system, a single photon emission computed tomography (SPECT) imaging system, and combinations thereof (e.g., a multi-modal imaging system such as a PET/CT, PET/MR, or SPECT/CT imaging system). As an example, the embodiments of the present disclosure will be described below in conjunction with X-ray computed tomography (CT) imaging. It will be understood by those skilled in the art that the embodiments of the present disclosure may also be applied to other medical imaging.

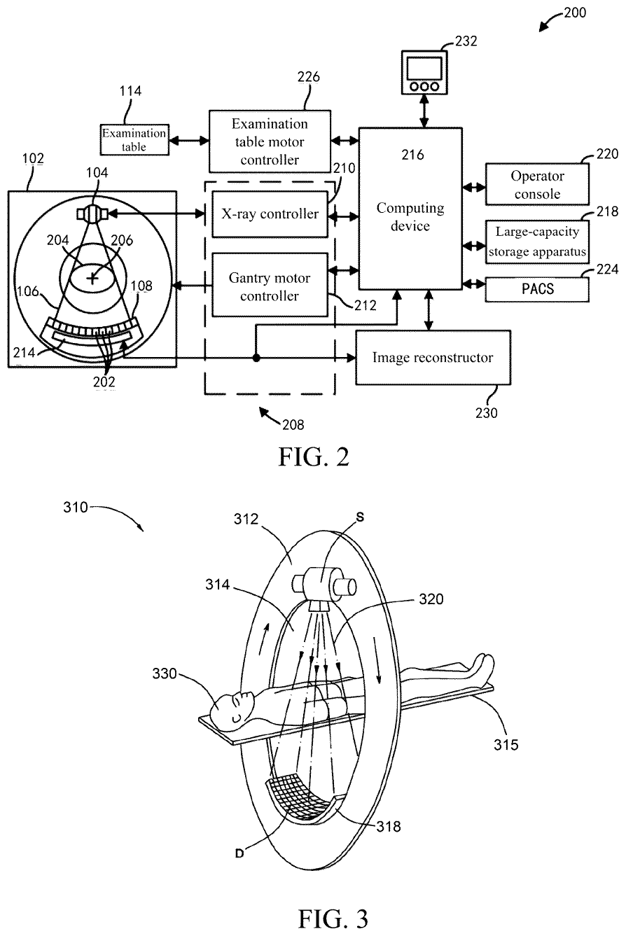

FIG. 1 shows a schematic diagram of an exemplary CT system 100 configured for CT imaging. Specifically, the CT system 100 is configured to image a subject 112 (such as a patient, an inanimate object, or one or more manufactured components) and/or a foreign object (such as a dental implant, a stent, and/or a contrast agent present in the body). In one implementation, the CT system 100 includes a gantry 102, which in turn may further include at least one X-ray source 104. The at least one X-ray source is configured to project an X-ray radiation beam 106 (see FIG. 2) for imaging the subject 112 lying on an examination table 114. Specifically, the X-ray source 104 is configured to project the X-ray radiation beam 106 toward a detector array 108 positioned on the opposite side of the gantry 102. Although FIG. 1 depicts a single X-ray source 104, in certain implementations, a plurality of X-ray sources and detectors may be used to project a plurality of X-ray radiation beams, so as to acquire projection data corresponding to the patient at different energy levels. In some implementations, the X-ray source 104 may enable dual-energy gemstone spectral imaging (GSI) by means of rapid peak kilovoltage (kVp) switching. In some implementations, the X-ray detectors employed are photon counting detectors capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In some implementations, the CT system 100 further includes an image processing unit 110, which is configured to reconstruct an image of a target volume of the subject 112 by using an iterative or analytical image reconstruction method. For example, the image processing unit 110 may reconstruct an image of a target volume of the patient by using an analytical image reconstruction method such as filtered back projection (FBP). As another example, the image processing unit 110 may reconstruct the image of the target volume of the subject 112 by using an iterative image reconstruction method (e.g., advanced statistical iterative reconstruction (ASIR), conjugate gradient (CG), maximum likelihood expectation maximization (MLEM), model-based iterative reconstruction (MBIR), etc.). As further described herein, in some examples, in addition to the iterative image reconstruction method, the image processing unit 110 may use an analytical image reconstruction method (such as FBP).

In some CT imaging system configurations, the X-ray source projects a conical X-ray radiation beam, which is collimated to be located within an X-Y-Z plane of a Cartesian coordinate system, and the plane is usually referred to as an “imaging plane”. The X-ray radiation beam passes through an object being imaged, such as a patient or a subject. The X-ray radiation beam is irradiated on a detector element array after being attenuated by the object. The intensity of the attenuated X-ray radiation beam received at the detector array depends on the attenuation of the X-ray radiation beam by the object. Each detector element of the array produces a separate electrical signal that is a measure of the X-ray beam attenuation at the detector position. Attenuation measurements from all detector elements are separately acquired to generate a transmission profile.

In some CT systems, a gantry is used to rotate the X-ray source and the detector array in the imaging plane around an object to be imaged so that the angle at which the X-ray beam intersects the object is constantly changing. A set of X-ray radiation attenuation measurement results (e.g., projection data) from the detector array at one gantry angle is referred to as a “view”. A “scan” of the object includes a set of views made at different gantry angles or viewing angles during one rotation of the X-ray source and detector. It can be contemplated that benefits of the method described herein derive from a medical imaging modality other than CT. Therefore, as used herein, the term “view” is not limited to the use described above with respect to projection data from one gantry angle. The term “view” is used to mean one data acquisition when there are a plurality of data acquisitions (acquisitions from CT, positron emission tomography (PET), or single photon emission CT (SPECT)) from different angles, and/or any other modality (including a modality to be developed) and combinations thereof in fused implementations.

Projection data is processed to reconstruct images corresponding to two-dimensional slices acquired by means of the object, or in some examples in which the projection data includes a plurality of views or scans, reconstruct images corresponding to three-dimensional images of the object. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be performed. To perform the “helical” scan, the patient is moved when data of a specified number of slices is acquired. Such systems produce a single helix from helical scanning of a conical beam. The helix mapped out by the conical beam produces projection data according to which an image in each specified slice can be reconstructed.

As used herein, the phrase “reconstructed image” is not intended to exclude implementations in which data representing an image is generated rather than a viewable image. Therefore, as used herein, the term “image” broadly refers to both a viewable image and data representing a viewable image. However, many embodiments generate (or are configured to generate) at least one viewable image.

FIG. 2 shows an exemplary imaging system 200 similar to the CT system 100 in FIG. 1. According to aspects of the present disclosure, the imaging system 200 is configured to image a subject 204 (e.g., the subject 112 of FIG. 1). In one implementation, the imaging system 200 includes the detector array 108 (see FIG. 1). The detector array 108 further includes a plurality of detector elements 202, which together sense the X-ray radiation beam 106 (see FIG. 2) passing through the subject 204 (such as the patient) to acquire corresponding projection data. Therefore, in one implementation, the detector array 108 is fabricated in a multi-line or multi-row configuration including a plurality of lines or rows of units or detector elements 202. In such a configuration (e.g., multi-line or multi-row detector CT or MDCT), one or more additional lines of detector elements 202 are arranged in a parallel configuration for acquiring projection data. The configuration may include 4, 8, 16, 32, 64, 128, or 256 lines or rows of detector elements. For example, a 64-line MDCT scanner may have 64 lines or rows of detector elements, and a 256-line MDCT scanner may have 256 lines or rows of detector elements. Therefore, four rotations of a helical scan performed by a 64-line or 64-row MDCT scanner may achieve a detector coverage equal to a single rotation of a scan performed by a 256-line or 256-row MDCT scanner.

In certain implementations, the imaging system 200 is configured to traverse different angular positions around the subject 204 to acquire required projection data. Therefore, the gantry 102 and components mounted thereon can be configured to rotate about a center of rotation 206 to acquire projection data at different energy levels, for example. Alternatively, in implementations in which the projection angle with respect to the subject 204 changes over time, the mounted components may be configured to move along a substantially curved line rather than a segment of a circumference.

Therefore, when the X-ray source 104 and the detector array 108 rotate, the detector array 108 collects the data of the attenuated X-ray beam. The data collected by the detector array 108 is then subjected to pre-processing and calibration to adjust the data so as to represent a line integral of an attenuation coefficient of the scanned subject 204. The processed data is generally referred to as a projection.

In some examples, an individual detector or detector element 202 in the detector array 108 may include a photon counting detector that registers interactions of individual photons into one or more energy bins. It should be understood that the methods described herein may also be implemented using an energy integration detector.

An acquired projection data set may be used for base material decomposition (BMD). During the BMD, the measured projection is converted to a set of material density projections. The material density projections may be reconstructed to form one pair or a set of material density maps or images (such as bone, soft tissue, and/or contrast agent maps) of each corresponding base material. The density maps or images may then be associated to form a 3D volumetric image of a base material (e.g., bone, soft tissue, and/or a contrast agent) in an imaging volume.

Once reconstructed, a base material image produced by the imaging system 200 displays internal features of the subject 204 represented by the densities of two base materials. The density images can be displayed to demonstrate the foregoing features. In a conventional method for diagnosing medical conditions (such as disease states), and more generally for diagnosing medical events, a radiologist or physician considers a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control the movement of components, such as the rotation of the gantry 102 and the operation of the X-ray source 104. In certain implementations, the control mechanism 208 further includes an X-ray controller 210, configured to provide power and timing signals to the X-ray source 104. Additionally, the control mechanism 208 includes a gantry motor controller 212, configured to control the rotational speed and/or position of the gantry 102 on the basis of imaging requirements.

In certain implementations, the control mechanism 208 further includes a data acquisition system (DAS) 214, configured to sample analog data received from the detector elements 202, and convert the analog data to a digital signal for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or large-capacity storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In certain embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows one operator console 220, more than one operator console may be coupled to the imaging system 200, for example, for inputting or outputting system parameters, requesting examination, mapping data, and/or viewing images. Moreover, in certain implementations, the imaging system 200 may be coupled to, for example, a plurality of displays, printers, workstations, and/or similar devices located locally or remotely within an institution or hospital or in a completely different location via one or more configurable wired and/or wireless networks (such as the Internet and/or a virtual private network, a wireless telephone network, a wireless local area network, a wired local area network, a wireless wide area network, a wired wide area network, etc.).

In one implementation, for example, the imaging system 200 includes a picture archiving and communication system (PACS) 224 or is coupled to the PACS. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-supplied and/or system-defined commands and parameters to operate an examination table motor controller 226, which can in turn control the examination table 114. The examination table may be an electric examination table. Specifically, the examination table motor controller 226 may move the examination table 114 to properly position the subject 204 in the gantry 102, so as to acquire projection data corresponding to a target volume of the subject 204.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster may be used for the image reconstructor 230.

In one embodiment, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

FIG. 3 shows a schematic diagram of a CT system when examining a patient. As shown in FIG. 3, the CT system 310 generally includes a rotatable gantry 312 and a support table 315 disposed in a hollow imaging region 314 of the rotatable gantry 312 for carrying a patient 330. The rotatable gantry 312 includes an X-ray source S and a detector 318 disposed opposite to the X-ray source S, wherein the detector 318 includes a plurality of individual detector units D arranged in an array. When the rotatable gantry 312 is located at a certain scanning position, the X-ray source S emits a fan-shaped X-ray beam 320 toward the detector 318, and the plurality of detector units D respectively sense the X-rays attenuated by the patient 330, so that a set of projection data is obtained by the detector units D through sensing, thereby obtaining a corresponding frame of projection data. With the rotation of the rotatable gantry 312, the X-ray source S and the detector 318 rotate around a center of rotation O. The CT system 310 performs multiple scans, and in each scan process, all the detector units D may obtain each corresponding frame of projection data through sensing, and when the detector units D are normal, each corresponding frame of projection data may be directly used to reconstruct one or more images. A direction of the detector 318 in which an object under examination moves toward or out of the medical imaging system is referred to as a row direction, that is, a direction in which the object under examination on the support table 315 moves toward or out of the rotatable gantry 312. An extension direction of the detector 318, perpendicular to the row direction, arranged to partially surround the object under examination is referred to as a channel direction, that is, a direction in which the detector 318 is arranged in an arc shape along the rotatable gantry 312. Angles at which the detector 318 acquires raw projection data at different positions around the object under examination are referred to as view directions, that is, different angles at which the detector 318 surrounds the object under examination along the rotatable gantry 312.

In a digital X-ray imaging system, it is desirable to obtain clearer, higher resolution CT images to better identify tissue structures and features. Therefore, the images may be denoised by an artificial intelligence method. In the process of denoising a CT image, if denoising is to be performed by using the artificial intelligence method, to train an image denoising model, clean image data usually needs to be provided as ground truth in the training process. However, it is difficult to obtain clean image data for the CT image. Therefore, an image denoising model based on self-supervised learning may be used to denoise the CT image. However, if a raw image obtained by the imaging system is directly segmented into data pairs, due to the limited number of acquisitions in the row direction, the channel direction, and the view direction in the X-ray imaging process, the density of the raw image is limited, and consequently the segmented image data will become sparser, the data volume is insufficient, and the image outputted by the model may have defects such as stripes, artifacts, and undesirable patterns, which is unacceptable for medical images.

In view of the above problems, an implementation of the present disclosure proposes, in an innovative manner, a method for generating a medical imaging data pair.

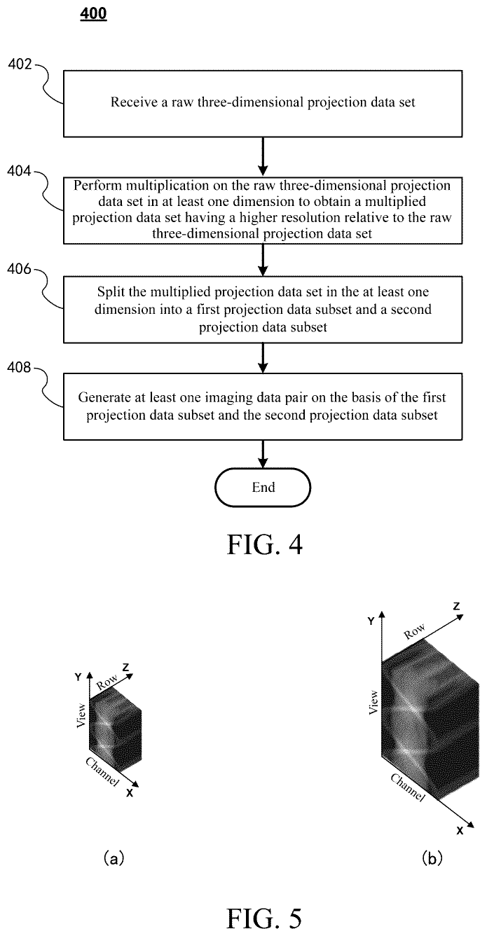

FIG. 4 shows a flowchart of a method 400 for generating a medical imaging data pair according to an embodiment of the present disclosure. At step 402, a raw three-dimensional projection data set is received. The raw three-dimensional projection data set is obtained by scanning an object under examination by a medical imaging system. Next, at step 404, multiplication is performed on the raw three-dimensional projection data set in at least one dimension to obtain a multiplied projection data set having a higher resolution relative to the raw three-dimensional projection data set. Then, at step 406, the multiplied projection data set is split into a first projection data subset and a second projection data subset in the at least one dimension. Finally, at step 408, at least one imaging data pair is generated on the basis of the first projection data subset and the second projection data subset. The imaging data pair includes an imaging data pair formed on the basis of the first projection data subset and the second projection data subset. Additionally or alternatively, the imaging data pair includes an imaging data pair formed by an image reconstructed from the first projection data subset and an image reconstructed from the second projection data subset.

By performing multiplication on the raw three-dimensional projection data set in at least one dimension, a multiplied projection data set having a higher resolution relative to the raw three-dimensional projection data set can be obtained. Compared with directly splitting the raw three-dimensional projection data set, the first projection data subset and the second projection data subset obtained by splitting the multiplied projection data set have a lower data sparsity, reducing the possibility of generating defects in an output of a model. Thus, the first projection data subset and the second projection data subset, provided as a data pair, help improve the performance of an image denoising model.

FIG. 5 shows a schematic diagram of a raw three-dimensional projection data set and a multiplied projection data set according to an embodiment of the present disclosure. The raw three-dimensional projection data set is a three-dimensional projection data set acquired by a detector of a medical imaging system. As an example, the raw three-dimensional projection data set is acquired by the detector 108 or 318 of the CT system 100, 200, or 310 described in FIGS. 1 to 3. In an embodiment, the medical imaging system may be a computed tomography (CT) medical imaging system, a positron emission tomography-computed tomography (PET-CT) medical imaging system, or a positron emission tomography (PET) medical imaging system. The raw three-dimensional projection data set shown in part (a) includes three dimensions, namely, a row direction (Z direction), a channel direction (X direction), and a view direction (Y direction). The row direction (Z direction) indicates a direction of the detector in which the object under examination moves toward or out of the medical imaging system, i.e., a scanning translation direction of the medical imaging system. As an example, the detector 108 or 318 of the CT system 100, 200, or 310 may be configured with different numbers of lines of detector units in the row direction (Z direction), which may include 8 lines, 16 lines, 32 lines, 64 lines, 256 lines, 512 lines, etc., for example. The channel direction (X direction) indicates an extension direction of the detector, perpendicular to the row direction, arranged to partially surround the object under examination, i.e., the width direction of the detector 108 or 318 of the medical imaging system. For example, there may be about 900 channels. The view direction (Y direction) indicates an angle at which the detector acquires the raw three-dimensional projection data set at different positions around the object under examination, for example, an angle or view angle at which the detector 108 or 318 rotates with the gantry when a view is acquired by the CT system 100, 200, or 310 described in the foregoing FIGS. 1 to 3. For example, in an axial scan, the medical imaging system may acquire raw projection data or views of about 1,000 angular positions, one angular position being referred to as one view angle.

In an embodiment, performing multiplication on the raw three-dimensional projection data set in at least one dimension includes up-sampling the raw three-dimensional projection data set in at least one of the channel direction, the row direction, and the view direction. The multiplication factors in different dimensions may be the same or different. The multiplication factor may be any suitable factor such as 2 times, 4 times, or 8 times. In an embodiment, multiplication in the channel direction and the row direction is performed using a different algorithm from multiplication in the view direction. As one example, within the channel and row plane, multiplication may be performed by using a neural network model suitable for a single image super-resolution (SISR) technique. As an example, in the view direction, up-sampling may be performed by using a deep learning neural network. For example, interpolation may be performed on the raw data, and then the interpolated data may be optimized by using the neural network model. For example, multiplication in the view direction may be implemented by using a SwinIR transformer (image restoration using a Swin transformer, or image restoration using a shifted window (Swin) transformer). By performing multiplication on the raw three-dimensional projection data set in at least one dimension, a multiplied projection data set having a higher resolution may be obtained. For the multiplied projection data set shown in part (b), multiplication has been performed in each of the channel direction, the row direction, and the view direction. By performing multiplication on the raw three-dimensional projection data set, defects such as artifacts like stripes, undesirable patterns, etc., caused in the reconstructed image due to the data sparsity of the split data set can be eliminated.

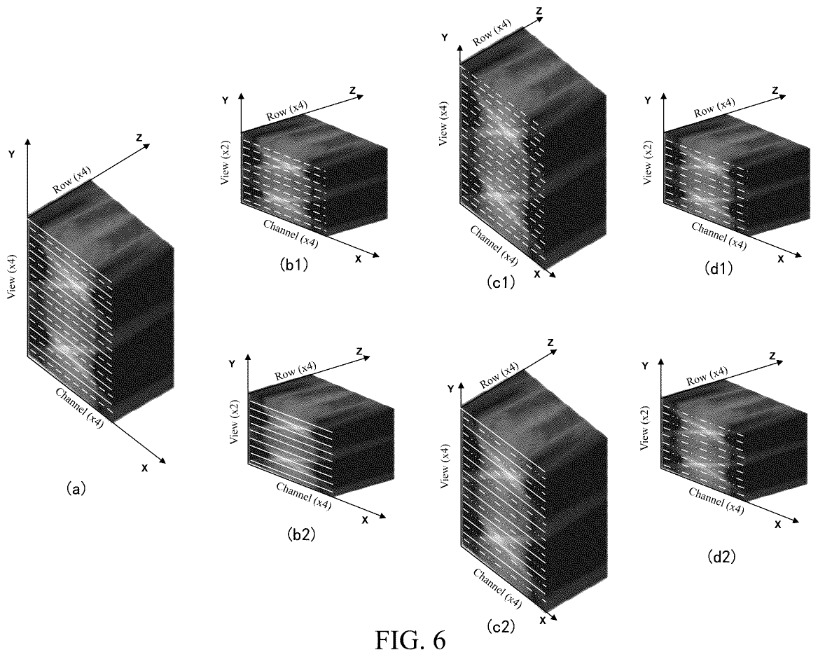

In an embodiment, the first projection data subset and the second projection data subset are obtained by alternately splitting the multiplied projection data set in the view direction. FIG. 6 shows a schematic diagram of splitting a multiplied projection data set in a view direction according to an embodiment of the present disclosure. For the multiplied projection data set shown in part (a), in this example, the multiplied projection data set is obtained by performing 4-fold multiplication on the raw three-dimensional projection data set in each of the channel direction, the row direction, and the view direction. Then, the multiplied projection data set is alternately split in the view direction to obtain a first projection data subset represented by a dashed line shown in part (b1) and a second projection data subset represented by a solid line shown in part (b2), wherein part (b1) is located at first positions in the view direction of part (a), part (b2) is located at second positions in the view direction of part (a), the first positions and the second positions alternate in the view direction, and therefore, the multiplication factor in the view direction of part (b1) and part (b2) is reduced to 2 times. Although the splits shown in the figure are equally spaced, in other embodiments, unequally spaced splits may also be used. For example, a smaller interval split is used at the center of the image, a larger interval split is used at the edge of the image, and so on.

In an embodiment, the method 400 further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

With continued reference to FIG. 6, interpolation is performed on the first projection data subset shown in part (b1) to obtain part (c1), wherein the interpolated part (d1) is represented by a one-dot chain line, and the multiplication factor in the view direction of the interpolated part shown in part (d1) is 2 times. Therefore, after interpolation, the multiplication factor in the view direction of part (c1) is increased to 4 times. Since the interpolated portion of part (d1) and the first projection data subset of part (b1) are alternately arranged, there is a correspondence with the second projection data subset shown in part (b2), and the interpolated portion shown in part (d1) is referred to as a pseudo second projection data subset herein. Therefore, the pseudo second projection data subset of part (d1) and the non-interpolated second projection data subset of part (b2) may form a medical imaging data pair.

Additionally or alternatively, similar processing may be performed on the second projection data subset shown in part (b2). Interpolation is performed on the second projection data subset shown in part (b2) to obtain part (c2), wherein the interpolated part (d2) is represented by a two-dot chain line, and the multiplication factor in the view direction of the interpolated portion shown in part (d2) is 2 times, so that after interpolation, the multiplication factor in the view direction of part (c2) is increased to 4 times. Since the interpolated portion of part (d2) and the second projection data subset of part (b2) are alternately arranged, there is a correspondence with the first projection data subset shown in part (b1), and the interpolated portion shown in part (d2) is referred to as a pseudo first projection data subset herein. Therefore, the pseudo first projection data subset of part (d2) and the non-interpolated first projection data subset of part (b1) may form a medical imaging data pair.

Additionally or alternatively, if the pseudo first projection data subset of part (d2) and the pseudo second projection data subset of part (d1) are alternately arranged to form a pseudo projection data set, the pseudo projection data set also has a correspondence with the multiplied projection data set of part (a). Therefore, the pseudo projection data set formed by alternately arranging the pseudo first projection data subset of part (d2) and the pseudo second projection data subset of part (d1) and the non-interpolated multiplied projection data set of part (a) may form a medical imaging data pair.

In an embodiment, the imaging data pair includes an imaging data pair formed by an image reconstructed from the first projection data subset and an image reconstructed from the second projection data subset. For example, the first projection data subset of part (b1) may be reconstructed into a first reconstructed image, the second projection data subset of part (b2) may be reconstructed into a second reconstructed image, and then the first reconstructed image and the second reconstructed image may be used as a medical imaging data pair.

Additionally or alternatively, part (c1) and part (c2) may respectively be reconstructed into reconstructed images to be used as a medical imaging data pair, or part (d1) and part (d2) may respectively be reconstructed into reconstructed images to be used as a medical imaging data pair, or part (b1) and part (d2) may respectively be reconstructed into reconstructed images to be used as a medical imaging data pair, or part (d1) and part (b2) may respectively be reconstructed into reconstructed images to be used as a medical imaging data pair, or a data set formed by alternately arranging (d1) and (d2), and part (a) may respectively be reconstructed into reconstructed images to be used as a medical imaging data pair, and so on.

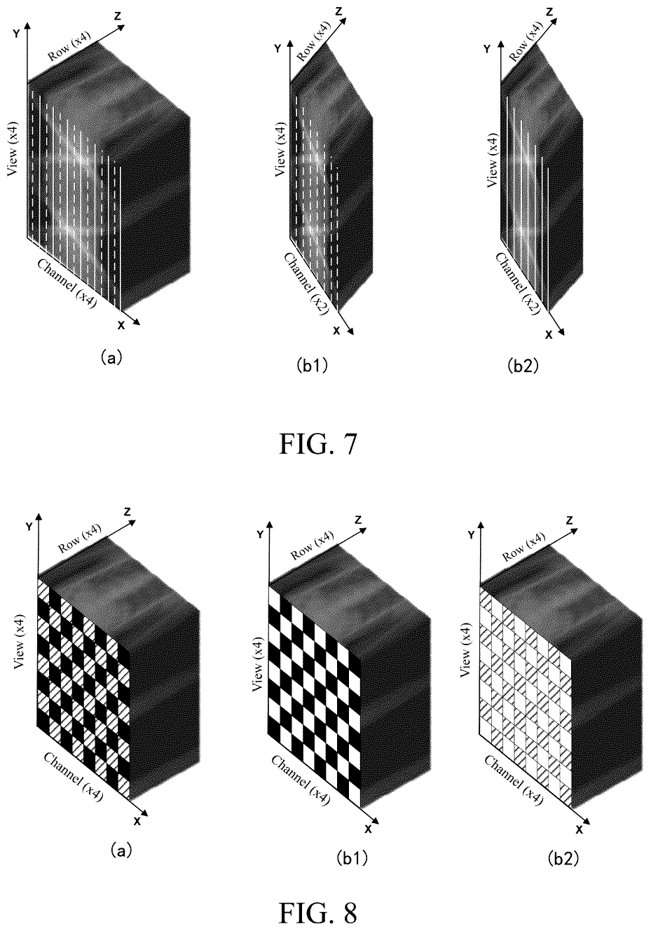

In an embodiment, the first projection data subset and the second projection data subset are obtained by alternately splitting the multiplied projection data set in the channel direction. FIG. 7 shows a schematic diagram of splitting a multiplied projection data set in a channel direction according to an embodiment of the present disclosure. For the multiplied projection data set shown in part (a), in this example, the multiplied projection data set is obtained by performing 4-fold multiplication on the raw three-dimensional projection data set in each of the channel direction, the row direction, and the view direction. Then, the multiplied projection data set is alternately split in the channel direction to obtain a first projection data subset represented by a dashed line shown in part (b1) and a second projection data subset represented by a solid line shown in part (b2), wherein part (b1) is located at third positions in the channel direction of part (a), part (b2) is located at fourth positions in the channel direction of part (a), the third positions and the fourth positions alternate in the channel direction, and therefore, the multiplication factor in the channel direction of part (b1) and part (b2) is reduced to 2 times. Although the splits shown in the figure are equally spaced, in other embodiments, unequally spaced splits may also be used. For example, a smaller interval split is used at the center of the image, a larger interval split is used at the edge of the image, and so on.

In an embodiment, the method 400 further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

With continued reference to FIG. 7, similar to the processing process of FIG. 6, interpolation is performed on the first projection data subset shown in part (b1) to obtain a pseudo second projection data subset, namely, an interpolated part. Therefore, the pseudo second projection data subset and the second projection data subset of part (b2) may form a medical imaging data pair.

Additionally or alternatively, similar to the processing process of FIG. 6, interpolation is performed on the second projection data subset shown in part (b2) to obtain a pseudo first projection data subset, namely, an interpolated part. Therefore, the pseudo first projection data subset and the first projection data subset of part (b1) may form a medical imaging data pair.

Additionally or alternatively, a pseudo projection data set formed by alternately arranging the pseudo first projection data subset and the pseudo second projection data subset and the non-interpolated multiplied projection data set of part (a) may form a medical imaging data pair.

In an embodiment, the imaging data pair includes an imaging data pair formed by an image reconstructed from the first projection data subset and an image reconstructed from the second projection data subset. For example, the first projection data subset of part (b1) may be reconstructed into a first reconstructed image, the second projection data subset of part (b2) may be reconstructed into a second reconstructed image, and then the first reconstructed image and the second reconstructed image may be used as a medical imaging data pair.

Additionally or alternatively, interpolated part (b1) and interpolated part (b2) may respectively be reconstructed into reconstructed images to be used as a medical imaging data pair, or the pseudo first projection data subset and the pseudo second projection data subset may respectively be reconstructed into reconstructed images to be used as a medical imaging data pair, or the first projection data subset and the pseudo second projection data subset may respectively be reconstructed into reconstructed images to be used as a medical imaging data pair, or the pseudo first projection data subset and the second projection data subset may respectively be reconstructed into reconstructed images to be used as a medical imaging data pair, or the data set formed by alternately arranging the pseudo first projection data subset and the pseudo second projection data subset and part (a) may respectively be reconstructed into reconstructed images to be used as a medical imaging data pair, and so on.

In an embodiment, the first projection data subset and the second projection data subset are obtained by alternately splitting the multiplied projection data set in the view direction and the channel direction. FIG. 8 shows a schematic diagram of splitting a multiplied projection data set in a view direction and a channel direction according to an embodiment of the present disclosure. For the multiplied projection data set shown in part (a), in this example, the multiplied projection data set is obtained by performing 4-fold multiplication on the raw three-dimensional projection data set in each of the channel direction, the row direction, and the view direction. Then, the multiplied projection data set is split alternately in the view direction and the channel direction to obtain a first projection data subset represented by black squares shown in part (b1) and a second projection data subset represented by slash squares shown in part (b2), wherein white squares represent no data, part (b1) is located at first positions in the view direction and third positions in the channel direction of part (a), part (b2) is located at second positions in the view direction and fourth positions in the channel direction of part (a), the first positions and the second positions alternate in the view direction, and the third positions and the fourth positions alternate in the channel direction. It should be understood that although FIG. 8 uses the terms of first position, second position, third position, and fourth position, these positions may be the same as or different from the positions in FIGS. 6 and 7. Although the splits shown in the figure are equally spaced, in other embodiments, unequally spaced splits may also be used. For example, a smaller interval split is used at the center of the image, a larger interval split is used at the edge of the image, and so on.

In an embodiment, the method 400 further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

With continued reference to FIG. 8, similar to the processing process of FIG. 6, interpolation is performed on the first projection data subset shown in part (b1) to obtain a pseudo second projection data subset, namely, an interpolated part. Therefore, the pseudo second projection data subset and the second projection data subset of part (b2) may form a medical imaging data pair.

Additionally or alternatively, similar to the processing process of FIG. 6, interpolation is performed on the second projection data subset shown in part (b2) to obtain a pseudo first projection data subset, namely, an interpolated part. Therefore, the pseudo first projection data subset and the first projection data subset of part (b1) may form a medical imaging data pair.

Additionally or alternatively, a pseudo projection data set formed by alternately arranging the pseudo first projection data subset and the pseudo second projection data subset and the non-interpolated multiplied projection data set of part (a) may form a medical imaging data pair.

In an embodiment, the imaging data pair includes an imaging data pair formed by an image reconstructed from the first projection data subset and an image reconstructed from the second projection data subset. For example, the first projection data subset of part (b1) may be reconstructed into a first reconstructed image, the second projection data subset of part (b2) may be reconstructed into a second reconstructed image, and then the first reconstructed image and the second reconstructed image may be used as a medical imaging data pair.

Additionally or alternatively, interpolated part (b1) and interpolated part (b2) may respectively be reconstructed into reconstructed images to be used as a medical imaging data pair, or the pseudo first projection data subset and the pseudo second projection data subset may respectively be reconstructed into reconstructed images to be used as a medical imaging data pair, or the first projection data subset and the pseudo second projection data subset may respectively be reconstructed into reconstructed images to be used as a medical imaging data pair, or the pseudo first projection data subset and the second projection data subset may respectively be reconstructed into reconstructed images to be used as a medical imaging data pair, or the data set formed by alternately arranging the pseudo first projection data subset and the pseudo second projection data subset and part (a) may respectively be reconstructed into reconstructed images to be used as a medical imaging data pair, and so on.

Therefore, in the method for generating a medical imaging data pair proposed by the present disclosure, multiplication is performed on the raw data, and then the multiplied data is split, so that the data density of the generated medical imaging data pair is improved, which helps the image denoising model generate higher-resolution images and eliminate defects in the images.

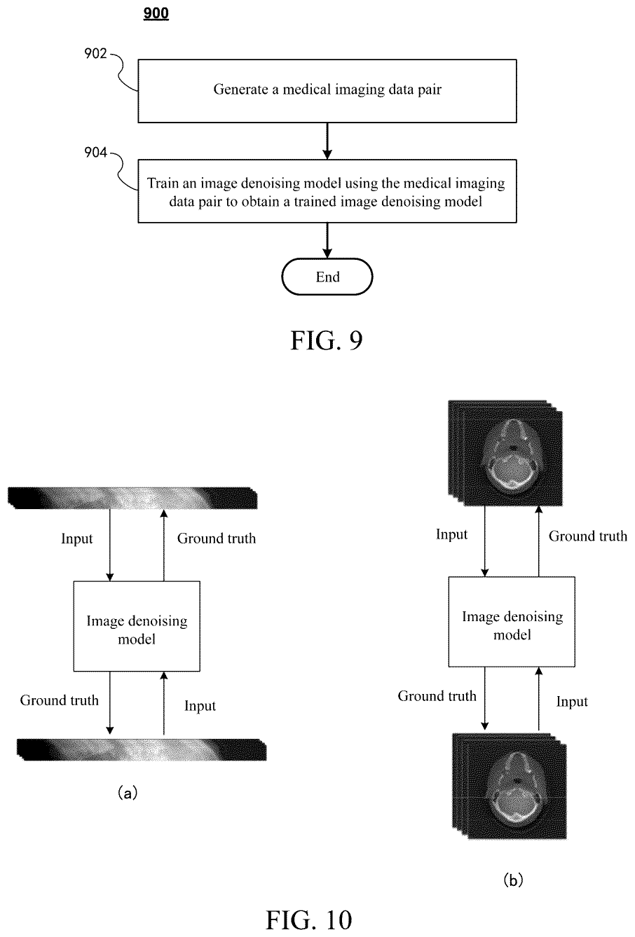

FIG. 9 shows a flowchart of a method 900 for model training according to an embodiment of the present disclosure. At step 902, a medical imaging data pair is generated. The method 400 may be used to generate the medical imaging data pair. At step 904, an image denoising model is trained using the medical imaging data pair to obtain a trained image denoising model. In an embodiment, the image denoising model is a Noise2Noise model. The Noise2Noise model is a model based on self-supervised learning. If image data used as input and ground truth are noise-correlated, the model can learn denoised image data without requiring clean image data as supervision.

FIG. 10 shows a schematic diagram of training an image denoising model using a medical imaging data pair according to an embodiment of the present disclosure. Part (a) shows training the image denoising model using projection data as a medical imaging data pair. For example, the image denoising model may be trained using a pseudo second projection data subset and a second projection data subset as the medical imaging data pair. In the direction shown on the left side, it is possible to use the pseudo second projection data subset as the input of the image denoising model and the second projection data subset as the ground truth of the image denoising model to train the image denoising model. Conversely, in the direction shown on the right side, it is possible to use the second projection data subset as the input of the image denoising model and the pseudo second projection data subset as the ground truth of the image denoising model to train the image denoising model. Similarly, the image denoising model may be trained using other medical imaging data pairs generated on the basis of projection data described with reference to FIG. 6 to FIG. 8. Finally, the image denoising model trained by using the projection data as the medical imaging data pair may be used to generate denoised projection data on the basis of the raw projection data, so as to reconstruct an image.

Part (b) shows training an image denoising model using reconstructed images as a medical imaging data pair. For example, the image denoising model may be trained using a first reconstructed image reconstructed from the first projection data subset and a second reconstructed image reconstructed from the second projection data subset as a medical imaging data pair. In the direction shown on the left side, it is possible to use the first reconstructed image as the input of the image denoising model and the second reconstructed image as the ground truth of the image denoising model to train the image denoising model. Conversely, in the direction shown on the right side, it is possible to use the second reconstructed image as the input of the image denoising model and the first reconstructed image as the ground truth of the image denoising model to train the image denoising model. Similarly, the image denoising model may be trained using other medical imaging data pairs generated on the basis of reconstructed images discussed with reference to FIG. 6 to FIG. 8. Finally, the image denoising model trained by using the reconstructed images as the medical imaging data pair may be used to generate a denoised reconstructed image on the basis of the raw reconstructed image.

As one example, training the image denoising model using the medical imaging data pair may include: generating a prediction result on the basis of the input by using the image denoising model, calculating a loss function between the prediction result and the ground truth, and updating parameters of the image denoising model on the basis of the loss function to obtain a trained image denoising model. Other suitable methods of training the image denoising model using the medical imaging data pair are also optional.

Therefore, the method for model training proposed by the present disclosure enables an image denoising model trained using the same to have higher performance, so that the generated medical image has a higher resolution and does not have defects such as artifacts, stripes, and undesirable patterns.

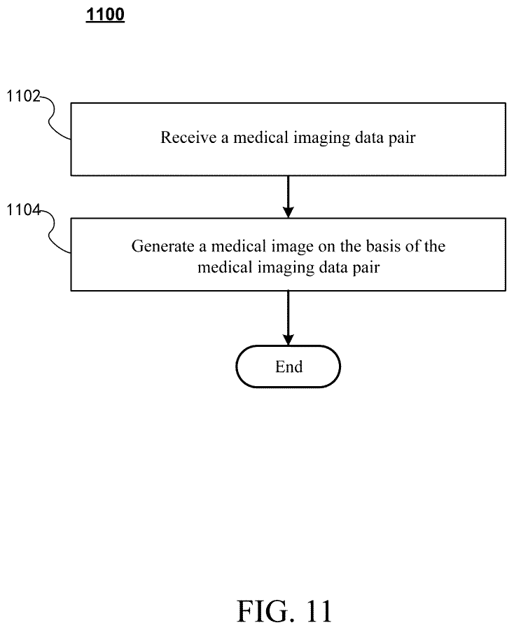

FIG. 11 shows a flowchart of a method 1100 for medical image imaging according to an embodiment of the present disclosure. The method 1100 may be performed by an image denoising model. At step 1102, a medical imaging data pair is received. The medical imaging data pair is generated by the following steps: receiving a raw three-dimensional projection data set, wherein the raw three-dimensional projection data set is obtained by scanning an object under examination by a medical imaging system; performing multiplication on the raw three-dimensional projection data set in at least one dimension to obtain a multiplied projection data set having a higher resolution relative to the raw three-dimensional projection data set; splitting the multiplied projection data set in the at least one dimension into a first projection data subset and a second projection data subset; and generating at least one imaging data pair on the basis of the first projection data subset and the second projection data subset, the imaging data pair including an imaging data pair formed on the basis of the first projection data subset and the second projection data subset and/or an imaging data pair formed by an image reconstructed from the first projection data subset and an image reconstructed from the second projection data subset. At step 1104, a medical image is generated on the basis of the medical imaging data pair. In an embodiment, the image denoising model may be trained by using the method 900.

In an embodiment, the raw three-dimensional projection data set is acquired by a detector of the medical imaging system and includes three dimensions: a row direction, a channel direction, and a view direction, the row direction indicating a direction of the detector in which the object under examination moves toward or out of the medical imaging system, the channel direction indicating an extension direction of the detector, perpendicular to the row direction, arranged to partially surround the object under examination, and the view direction indicating an angle at which the detector acquires the raw three-dimensional projection data set at different positions around the object under examination.

In an embodiment, the first projection data subset and the second projection data subset are obtained by alternately splitting the multiplied projection data set in the view direction and/or the channel direction.

In an embodiment, the first projection data subset includes data blocks at first positions in the view direction, and the second projection data subset includes data blocks at second positions in the view direction, the first positions and the second positions alternating in the view direction; and/or the first projection data subset includes data blocks at third positions in the channel direction, and the second projection data subset includes data blocks at fourth positions in the channel direction, the third positions and the fourth positions alternating in the channel direction.

In an embodiment, the method further includes performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

In an embodiment, performing multiplication on the raw three-dimensional projection data set in at least one dimension includes up-sampling the raw three-dimensional projection data set in at least one of the channel direction, the row direction, and the view direction.

In an embodiment, up-sampling the raw three-dimensional projection data set in the view direction includes using a deep learning neural network to perform up-sampling, the deep learning neural network including a SwinIR transformer.

In addition, the present disclosure further provides a medical imaging system, including: a scanning device configured to acquire a raw three-dimensional projection data set of an object under examination; and a processor configured to execute any one of the methods 400, 900, and 1100.

In addition, the present disclosure further provides a non-transient computer-readable medium, having instructions stored thereon, wherein the instructions are executable by a processor to implement any one of the methods 400, 900, and 1100.

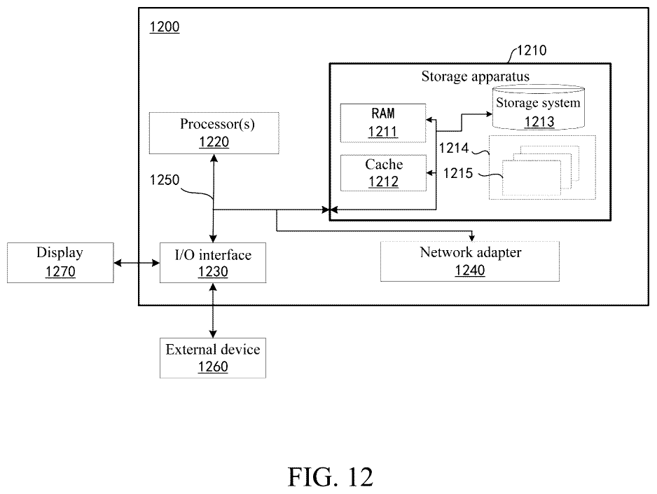

FIG. 12 shows a block diagram of an example of a computing device 1200 according to an embodiment of the present disclosure. The computing device 1200 may be implemented as an example of the computing device 216 shown in FIG. 2. The computing device 1200 includes: one or more processors 1220; and a storage apparatus 1210, configured to store one or more programs, wherein the one or more programs, when executed by the one or more processors 1220, cause the one or more processors 1220 to implement the processes described in the present disclosure. The processor is, for example, a digital signal processor (DSP), a microcontroller, an application-specific integrated circuit (ASIC), or a microprocessor.

The computing device 1200 shown in FIG. 12 is merely an example, and should not impose any limitation on the functions and scope of use of the embodiments of the present disclosure.

As shown in FIG. 12, the computing device 1200 is represented in the form of a general-purpose computing device. Components of the computing device 1200 may include, but are not limited to: one or more processors 1220, a storage apparatus 1210, and a bus 1250 connecting different system components (including the storage apparatus 1210 and the processor(s) 1220).

The bus 1250 represents one or more of several types of bus structures, including a memory bus or a memory controller, a peripheral bus, an accelerated graphics port, a processor, or a local bus using any one of a plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The computing device 1200 typically includes a plurality of types of computer system-readable media. These media may be any available medium that can be accessed by the computing device 1200, including volatile and non-volatile media, and removable and non-removable media.

The storage apparatus 1210 may include a computer system-readable medium in the form of a volatile memory, for example, a random access memory (RAM) 1211 and/or a cache memory 1212. The computing device 1200 may further include other removable/non-removable, and volatile/non-volatile computer system storage media. Only as an example, a storage system 1213 may be configured to read/write a non-removable, non-volatile magnetic medium (not shown in FIG. 12, typically referred to as a “hard disk drive”). Although not shown in FIG. 12, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 1250 by means of one or more data medium interfaces. The storage apparatus 1210 may include at least one program product which has a group of program modules (for example, at least one program module) configured to execute the functions of the embodiments of the present disclosure.

A program/utility tool 1214 having a group of program modules (at least one program module) 1215 may be stored in, for example, the storage apparatus 1210. This program module 1215 includes, but is not limited to, an operating system, one or more applications, other program modules, and program data, and each of these examples or a certain combination thereof may include an implementation of a network environment. The program module 1215 typically executes the function and/or method in any embodiment described in the present disclosure.

The computing device 1200 may also communicate with one or more external devices 1260 (such as a keyboard, a pointing device, and a display 1270), and may also communicate with one or more devices that enable a user to interact with the computing device 1200, and/or communicate with any device (such as a network card and a modem) that enables the computing device 1200 to communicate with one or more other computing devices. Such communication may be carried out by means of an input/output (I/O) interface 1230. Moreover, the computing device 1200 may also communicate, by means of a network adapter 1240, with one or more networks (for example, a local area network (LAN), a wide area network (WAN) and/or a public network, for example, the Internet). As shown in FIG. 12, the network adapter 1240 communicates, by means of the bus 1250, with other modules of the computing device 1200. It should be understood that although not shown in the figure, other hardware and/or software modules can be used in conjunction with the computing device 1200, the hardware and/or software modules including, but not limited to: microcode, device drivers, redundant processing units, external disk drive arrays, RAID systems, tape drives, data backup storage systems, and the like.

The processor 1220 executes, by running programs stored in the storage apparatus 1210, various functional applications and data processing, for example, implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or a plurality of aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In an example, the network interface device may include one or a plurality of physical jacks (for example, Ethernet, coaxial, or phone jacks) or one or a plurality of antennas for connection to the communication network. In an example, the network interface device may include a plurality of antennas that wirelessly communicate using at least one technique among single-input multiple-output (SIMO), multiple-input multiple-output (MIMO), or multiple-input single-output (MISO) techniques.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the method for generating a medical imaging data pair and the method for medical image imaging according to the present disclosure have been described, and the medical imaging system and the computer-readable storage medium that can implement the methods have been further described.

Some exemplary embodiments have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, device, or circuit are combined in other manners and/or replaced or supplemented with additional components or equivalents thereof; accordingly, the modified other implementations also fall within the scope of protection of the claims.

1. A method for generating a medical imaging data pair, comprising:
receiving a raw three-dimensional projection data set, wherein the raw three-dimensional projection data set is obtained by scanning an object under examination by a medical imaging system;
performing multiplication on the raw three-dimensional projection data set in at least one dimension to obtain a multiplied projection data set having a higher resolution relative to the raw three-dimensional projection data set;
splitting the multiplied projection data set in the at least one dimension into a first projection data subset and a second projection data subset; and
generating at least one imaging data pair on the basis of the first projection data subset and the second projection data subset, the imaging data pair including an imaging data pair formed on the basis of the first projection data subset and the second projection data subset and/or an imaging data pair formed by an image reconstructed from the first projection data subset and an image reconstructed from the second projection data subset.

2. The method according to claim 1, wherein the raw three-dimensional projection data set is acquired by a detector of the medical imaging system and includes a row direction, a channel direction, and a view direction, the row direction indicating a direction of the detector in which the object under examination moves toward or out of the medical imaging system, the channel direction indicating an extension direction of the detector, perpendicular to the row direction, arranged to partially surround the object under examination, and the view direction indicating an angle at which the detector acquires the raw three-dimensional projection data set at different positions around the object under examination.

3. The method according to claim 2, wherein the first projection data subset and the second projection data subset are obtained by splitting the multiplied projection data set alternately in the view direction and/or the channel direction.

4. The method according to claim 3, wherein the first projection data subset includes data blocks at first positions in the view direction, and the second projection data subset includes data blocks at second positions in the view direction, the first positions and the second positions alternating in the view direction; and/or
the first projection data subset includes data blocks at third positions in the channel direction, and the second projection data subset includes data blocks at fourth positions in the channel direction, the third positions and the fourth positions alternating in the channel direction.

5. The method according to claim 1, further including performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

6. The method according to claim 2, wherein performing multiplication on the raw three-dimensional projection data set in at least one dimension includes up-sampling the raw three-dimensional projection data set in at least one of the channel direction, the row direction, and the view direction.

7. The method according to claim 6, wherein up-sampling the raw three-dimensional projection data set in the view direction includes using a deep learning neural network to perform up-sampling, the deep learning neural network including a SwinIR transformer.

8. A method for medical image imaging, comprising:
receiving a medical imaging data pair, wherein the medical imaging data pair is generated by the following steps:
receiving a raw three-dimensional projection data set, wherein the raw three-dimensional projection data set is obtained by scanning an object under examination by a medical imaging system;
performing multiplication on the raw three-dimensional projection data set in at least one dimension to obtain a multiplied projection data set having a higher resolution relative to the raw three-dimensional projection data set;
splitting the multiplied projection data set in the at least one dimension into a first projection data subset and a second projection data subset; and
generating at least one imaging data pair on the basis of the first projection data subset and the second projection data subset, the imaging data pair including an imaging data pair formed on the basis of the first projection data subset and the second projection data subset and/or an imaging data pair formed by an image reconstructed from the first projection data subset and an image reconstructed from the second projection data subset; and
generating a medical image on the basis of the medical imaging data pair.

9. The method according to claim 8, wherein the raw three-dimensional projection data set is acquired by a detector of the medical imaging system and includes three dimensions: a row direction, a channel direction, and a view direction, the row direction indicating a direction of the detector in which the object under examination moves toward or out of the medical imaging system, the channel direction indicating an extension direction of the detector, perpendicular to the row direction, arranged to partially surround the object under examination, and the view direction indicating an angle at which the detector acquires the raw three-dimensional projection data set at different positions around the object under examination.

10. The method according to claim 9, wherein the first projection data subset and the second projection data subset are obtained by splitting the multiplied projection data set alternately in the view direction and/or the channel direction.

11. The method according to claim 10, wherein the first projection data subset includes data blocks at first positions in the view direction, and the second projection data subset includes data blocks at second positions in the view direction, the first positions and the second positions alternating in the view direction; and/or
the first projection data subset includes data blocks at third positions in the channel direction, and the second projection data subset includes data blocks at fourth positions in the channel direction, the third positions and the fourth positions alternating in the channel direction.

12. The method according to claim 8, further including performing interpolation on at least one of the first projection data subset and the second projection data subset in the imaging data pair, and then forming at least one imaging data pair on the basis of an interpolated portion of the interpolated one of the first projection data subset and the second projection data subset and the projection data subset of the non-interpolated one.

13. The method according to claim 8, wherein performing multiplication on the raw three-dimensional projection data set in at least one dimension includes up-sampling the raw three-dimensional projection data set in at least one of a channel direction, a row direction, and a view direction.
